(19) United States
(12) Patent Application Publication
(10) Pub. No.: US 2007/0157835 A1
(43) Pub. Date: Jul. 12, 2007

(54) METHOD FOR MOUNTING A PRINTING PLATE ON A MOUNTING PLATE

(76) Inventor: TRACY KUCABA, South Elgin, IL (US)

Correspondence Address: CARDINAL LAW GROUP, Suite 2000, 1603 Orrington Avenue, Evanston, IL, 60201, US

(21) Appl. No.: 11/617,492

(22) Filed: Dec. 28, 2006

Related U.S. Application Data
(60) Provisional application No. 60/754,718, filed on Dec. 29, 2005.
(60) Provisional application No. 60/771,317, filed on Feb. 8, 2006.

(51) Int. Cl. B41F 27/00

(52) U.S. Cl. 101/382.1

(57) ABSTRACT

An imaging system employing a printing plate and a mounting plate. The printing plate includes a printable plate body, and a mounting channel extending through the printable plate body. The mounting plate is used to mount the printing plate thereon during an execution of an imaging method (e.g., an indicia formation process and/or a pad printing process). The mounting plate includes a mountable plate body, a magnetic coupling channel extending into the mountable plate body and a magnetic coupler. The magnetic coupler includes a base magnetic member (e.g., a magnet) embedded in the mountable plate body, and an insertable magnetic member (e.g., a magnetic shaft) that can be magnetically coupled to the base magnetic member in response to the insertable magnetic member being concurrently inserted through the mounting channel of the printing plate and into the magnetic coupling channel.

### RELATED APPLICATIONS

This application claims the benefit of U.S. Provisional Patent Applications 60/754,718 filed Dec. 29, 2005, and 60/771,317 filed on Feb. 8, 2006 the entirety of each of which is incorporated by reference herein.

### BACKGROUND OF THE INVENTION

The present invention generally relates to mounting a printing plate on a mounting plate. The present invention specifically relates to mounting a printing plate in the form of a cliché plate on a mounting plate for purposes of executing an imaging method (e.g., an indicia formation process involving a formation of indicia on the cliché plate and/or a pad printing process involving the transfer of ink within the indicia formed on the cliché plate to a printing pad).

FIG. 1 illustrates a top view of a standard printing plate 10 including a printable plate body 11 and four (4) mounting channels 12-15 extending through printable plate body 11. Mounting channels 12-15 are for mounting the printing plate 10 onto a piece of printing pad equipment via mounting pins extending through mounting channels 12-15. FIG. 2 illustrates a top view of a standard mounting plate 20 including a mountable plate body 21 to mount printable plate body 11 thereon.

When printable plate body 11 has a magnetic material composition (i.e., the material composition of printable plate body 11 exhibits a magnetic attraction to magnets), then an array of magnets 22 embedded in plate body 21 are magnetically coupled to printable plate body 11 to securely mount printing plate 10 on mounting plate 20 as shown in FIG. 3. Conversely, when printable plate body 11 has a non-magnetic material composition (i.e., the material composition of printing plate 10 does not exhibit a magnetic attraction to magnets), then other techniques are used to securely mount printing plate 10 on mounting plate 20, such as, for example, a clamping technique or a taping technique as known in the art. It is therefore desirable to provide a mounting plate suitable for securely mounting a printing plate thereon irrespective as to whether or not the printing plate has a magnetic material composition.

### SUMMARY OF THE INVENTION

The present invention provides a new and unique mounting plate for securely mounting a printing plate thereon for purposes of executing an imaging method (e.g., an indicia formation process involving a formation of indicia on the cliché plate and/or a pad printing process involving the transfer of ink within the indicia formed on the cliché plate to a printing pad).

In a first form of the present invention, a mounting plate comprises a mountable plate body, a magnetic coupling channel and a magnetic coupler for use in an imaging method involving a printing plate including a printable plate body and a mounting channel extending through the printable plate body. The magnetic coupling channel extends into the mountable plate body. The magnetic coupler includes a base magnetic member (e.g., a magnet) embedded in the mountable plate body, and an insertable magnetic member (e.g., a magnetic shaft) that can be magnetically coupled to the base magnetic member in response to the insertable magnetic member being concurrently inserted through the mounting channel of the printing plate and into the magnetic coupling channel.

In a second form of the present invention, an image processing system employs a printing plate and a mounting plate. The printing plate includes a printable plate body, and a mounting channel extending through the printable plate body. The mounting plate is used to mount the printing plate thereon. The mounting plate includes a mountable plate body, a magnetic coupling channel extending into the mountable plate body and a magnetic coupler. The magnetic coupler includes a base magnetic member (e.g., a magnet) embedded in the mountable plate body, and an insertable magnetic member (e.g., a magnetic shaft) that can be magnetically coupled to the base magnetic member in response to the insertable magnetic member being concurrently inserted through the mounting channel of the printing plate and into the magnetic coupling channel.

In a third form of the present invention, an imaging method involves a printing plate and a mounting plate. The printing plate includes a printable plate body and a mounting channel extending through the printable plate body. The mounting plate includes a mountable plate body, a magnetic coupling channel extending into the mountable plate body and a magnetic coupler including a base magnetic member embedded in the mountable plate body and an insertable magnetic member. The imaging method comprises a mounting of the printable plate body onto the mountable plate body and an insertion of the insertable magnetic member through the mounting channel of the printing plate and into the magnetic coupling channel of the mounting plate to thereby be magnetically coupled to the base magnetic member whereby the printable plate body is securely mounted to the mountable plate body.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 illustrates a top view of a printing plate as known in the art;

FIG. 2 illustrates a top view of a mounting plate as known in the art;

FIG. 3 illustrates a side view of a mounting of the printing plate illustrated FIG. 1 to the mounting plate illustrated in FIG. 2.

FIGS. 4 and 5 illustrate a top view and a side view, respectively, of one embodiment of a mounting plate in accordance with the present invention;

FIG. 6 illustrates a side view of one embodiment of a magnetic coupling pin in accordance with the present invention;

FIG. 7 illustrates a side view of a mounting of the printing plate illustrated FIG. 1 to the mounting plate illustrated in FIGS. 4 and 5; and

FIG. 8 illustrates a flow chart representative of one embodiment of an imaging method in accordance with the present invention.

These and other features and advantages of the present invention will be readily apparent from the following detailed description, in conjunction with the claims.

### DETAILED DESCRIPTION OF THE INVENTION

While the present invention is susceptible of embodiment in various forms, there is shown in the drawings and will hereinafter be described as a presently preferred embodiment with the understanding that the presently preferred embodiment is to be considered an exemplification of the present invention and is not intended to limit the present invention of the specific embodiment illustrated.

It should be understood that the title of this section of this specification, namely, “Detailed Description Of the Invention”, relates to a requirement of the United States Patent Office, and does not imply, nor should be inferred to limit the subject matter disclosed herein.

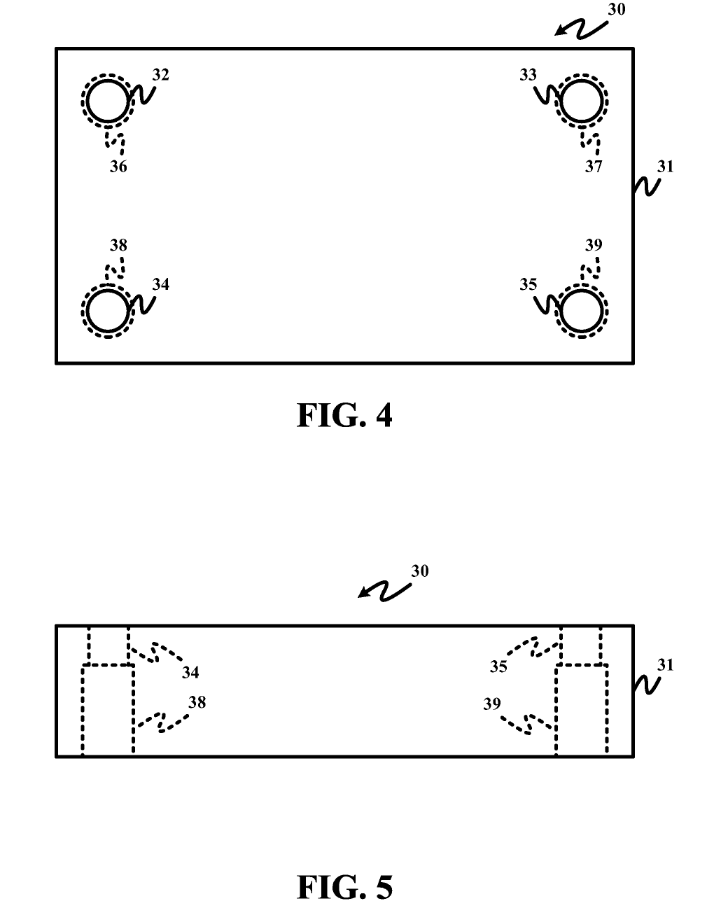

Referring now to the drawings, the present invention is premised on a magnetic coupler including a base magnetic member embedded in a mounting plate and an insertable magnetic member that can be inserted through a mounting channel of a printing plate and into a magnetic coupling channel of the mounting plate. To this end, FIG. 4 illustrates a mounting plate 30 of the present invention including a mountable plate body 31, four (4) magnetic coupling channels 32-35, and four (4) base magnetic members in the form of magnets 36-39. Each magnet 36-39 is embedded in a middle/lower area of mountable plate body 31 with an associated magnetic coupling channel 32-35 extending through an upper area of mountable plate body 31 to the magnet. This structural configuration is exemplarily shown in FIG. 5 with magnet 38 being embedded in a middle/lower area of mountable plate body 31 and associated magnetic coupling channel 34 extending through an upper area of mountable plate body 31 to magnet 38, and with magnet 39 being embedded in a middle/lower area of mountable plate body 31 and associated magnetic coupling channel 35 extending through an upper area of mountable plate body 31 to magnet 39.

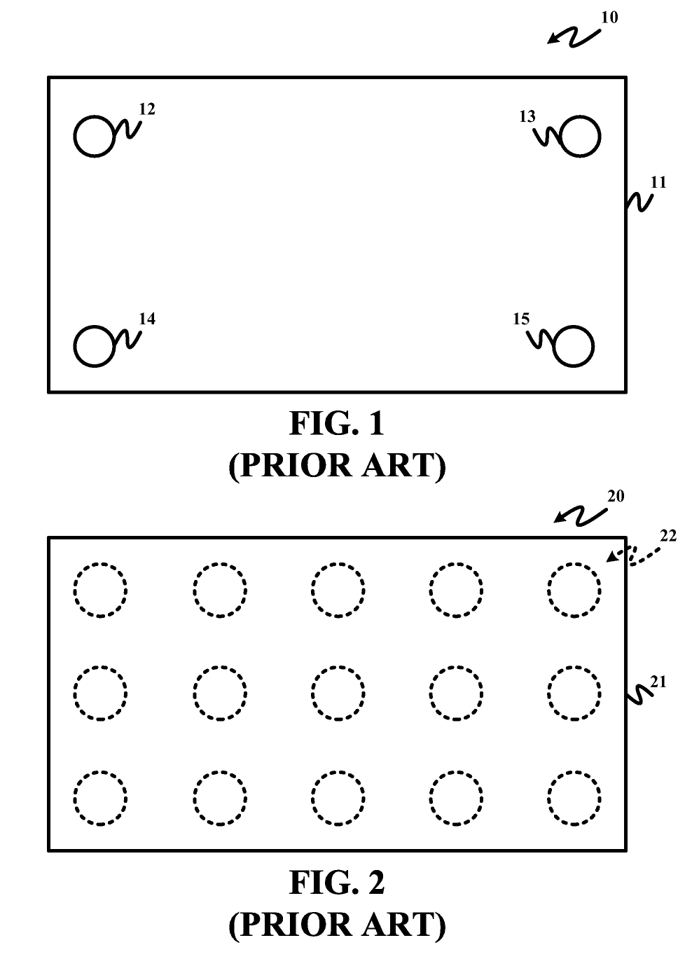

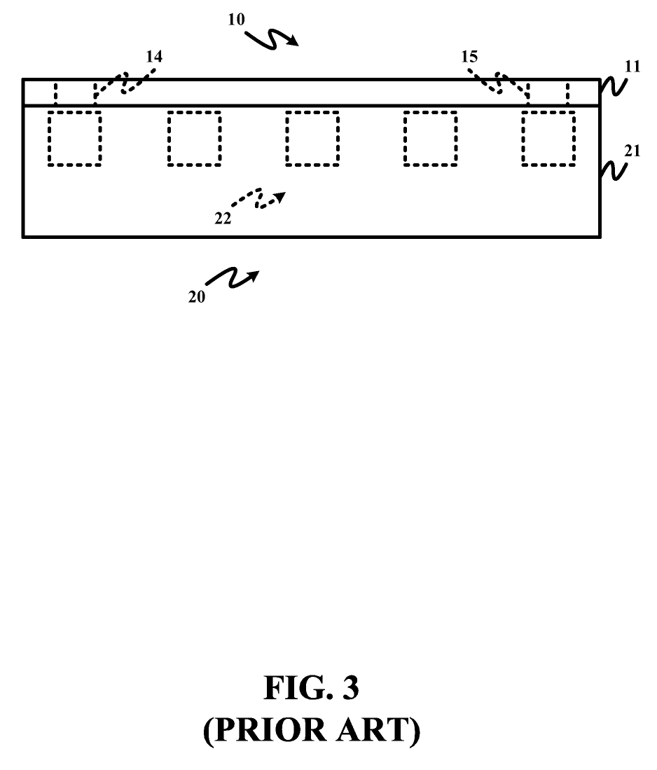

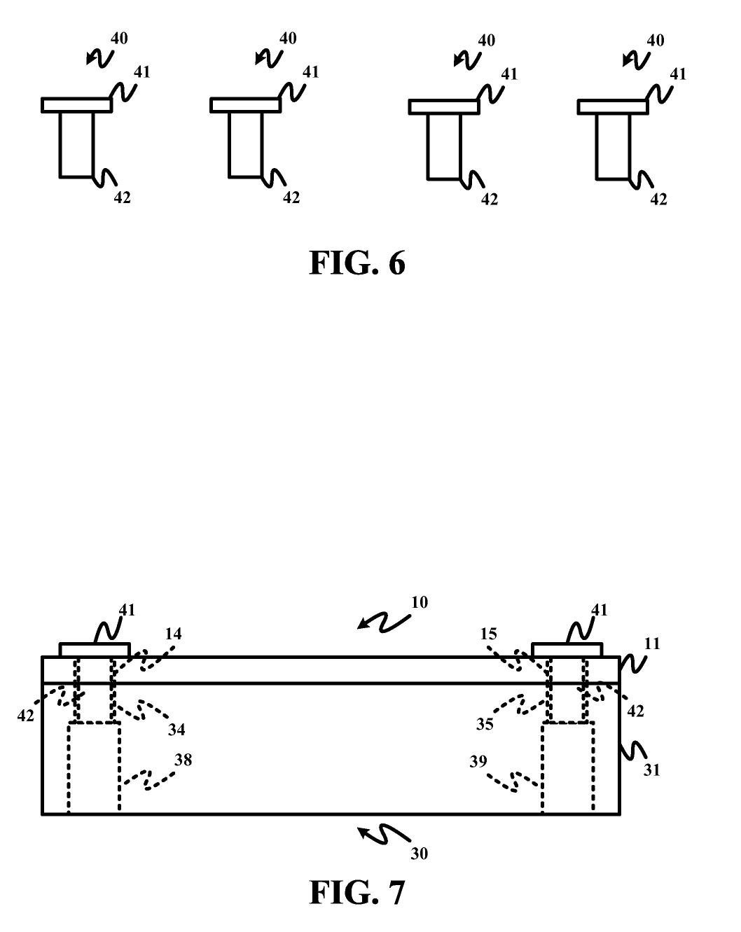

FIG. 6 illustrates four (4) insertable magnetic members in the form of magnetic coupling pins 40 with each pin having a head 41 and a shaft 42 downwardly extending from head 41 with head 41 optionally having a magnetic material composition and shaft 42 having a magnetic material composition (e.g., a ferrous material composition). Shaft 42 is sized and shaped to be concurrently inserted through one of the mounting channel 12-15 of printing plate 11 (FIG. 1) and into one of the magnetic coupling channel 32-35 of mounting plate 30 (FIGS. 4 and 5) to thereby be magnetically coupled to one of the magnets 36-39 of mounting plate 30. Each shaft 42 may be further sized and shaped to abut against the mounting channel, the magnetic coupling channel, and/or the magnet. Head 41 is sized and shaped to abut against printable plate body 11 in response to shaft 42 being concurrently inserted through one of the mounting channel 12-15 of printing plate 11 and into one of the magnetic coupling channel 32-35 of mounting plate 30.

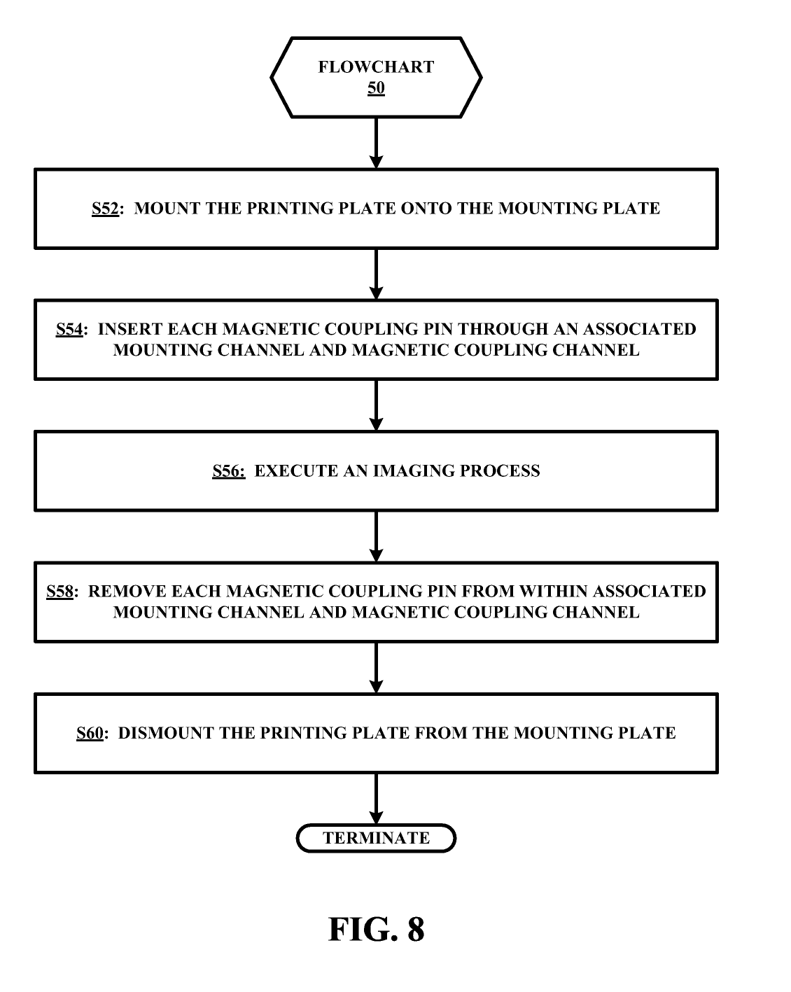

FIG. 8 illustrates a flowchart 50 representative of an imaging method of the present invention involving a use of printing plate 10 (FIG. 1) and mounting plate 30 (FIGS. 4 and 5). A stage S52 of flowchart 50 encompasses a mounting of printing plate 10 onto mounting plate 30 as shown in FIG. 7. A stage S54 of flowchart 50 encompasses four steps. The first step is an insertion of one of the magnetic coupling pins 40 through mounting channel 12 (FIG. 1) and into magnetic coupling channel 32 (FIG. 4) to thereby be magnetically coupled to magnet 36 (FIGS. 4 and 5). The second step is an insertion of one of the magnetic coupling pins 40 through mounting channel 13 (FIG. 1) and into magnetic coupling channel 33 to thereby be magnetically coupled to magnet 37. As shown in FIG. 7, the third step is an insertion of one of the magnetic coupling pins 40 through mounting channel 14 and into magnetic coupling channel 34 to thereby be magnetically coupled to magnet 38. As shown in FIG. 7, the final fourth step is an insertion of the last of the magnetic coupling pins 40 through mounting channel 15 and into magnetic coupling channel 35 to thereby be magnetically coupled to magnet 39.

A stage S56 of flowchart 50 encompasses an execution of an imaging process involving printing plate 10. In one embodiment, the imaging process is an indicia formation process involving a formation of indicia on printing plate 10 as would be appreciated by those having ordinary skill in the art. In a second embodiment, the imaging process is a pad printing process involving the transfer of ink within the indicia formed on printing plate 10 to a printing pad as would be appreciated by those having ordinary skill in the art. In a third embodiment, the imaging process consists of both the indicia formation process and the pad printing process.

A stage S58 of flowchart 50 encompasses a removal of each magnetic coupling pin 40 from its associated mounting channel 12-15 and magnetic coupling channel 32-35 to thereby eradicate the magnetic coupling to its associated magnet 36-39. A stage S60 of flowchart 60 encompasses a dismounting of printing plate 10 form mounting plate 30.

Referring to FIGS. 4-8, those having ordinary skill in the art will appreciate many advantages of a mounting plate made and used in accordance with the inventive principles of the present invention, including, but not limited to, the ability to securely mount a printing plate to the mounting plate in an expedient and simple manner irrespective of a material composition of the printing plate

In the disclosure, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims

What we claim is:

1. A mounting plate for use in an imaging method involving a printing plate including a printable plate body and a mounting channel extending through the printable plate body, the mounting plate comprising:
a mountable plate body;
a magnetic coupling channel extending into the mountable plate body; and
a magnetic coupler including
a base magnetic member embedded in the mountable plate body, and
an insertable magnetic member operable to be magnetically coupled to the base magnetic member in response to the insertable magnetic member being concurrently inserted through the mounting channel of the printing plate and into the magnetic coupling channel.

2. The mounting plate of claim 1, wherein the insertable magnetic member abuts the base magnetic member in response to the insertable magnetic member being concurrently inserted through the mounting channel of the printing plate and into the magnetic coupling channel.

3. The mounting plate of claim 1,
wherein the base magnetic member is a magnet; and
wherein the insertable magnetic member has a magnetic material composition.

4. The mounting plate of claim 1,
wherein the base magnetic member is imbedded in a first area of the mountable plate body; and
wherein the magnetic coupling channel extends from a mounting surface of the mountable plate body through a second area of the mountable plate body to the base magnetic member.

5. The mounting plate of claim 4, wherein the base magnetic member is a magnet.

6. The mounting plate of claim 1, wherein the insertable magnetic member includes a shaft operable to be concurrently inserted through the mounting channel of the printing plate and into the magnetic coupling channel.

7. The mounting plate of claim 6, wherein the insertable magnetic member further includes a head operable to abut a surface of the printable plate body in response to the shaft being concurrently inserted through the mounting channel of the printing plate and into the magnetic coupling channel.

8. The mounting plate of claim 6, wherein the shaft abuts the base magnetic member in response to the shaft being concurrently inserted through the mounting channel of the printing plate and into the magnetic coupling channel.

9. The mounting plate of claim 8,
wherein the base magnetic member is a magnet; and
wherein the shaft has a magnetic material composition.

10. An imaging system, comprising:
a printing plate including:
a printable plate body; and
a mounting channel extending through the printable plate body; and
a mounting plate operable to mount the printing plate during a formation of indicia on the printable plate body, the mounting plate including:
a mountable plate body;
a magnetic coupling channel extending into the mountable plate body; and
a magnetic coupler including:
a base magnetic member embedded in the mountable plate body; and
an insertable magnetic member operable to be magnetically coupled to the base magnetic member in response to the insertable magnetic member being concurrently inserted through the mounting channel of the printing plate and into the magnetic coupling channel.

11. The imaging system of claim 10, wherein the insertable magnetic member abuts the base magnetic member in response to the insertable magnetic member being concurrently inserted through the mounting channel of the printing plate and into the magnetic coupling channel.

12. The imaging system of claim 10,
wherein the base magnetic member is a magnet; and
wherein the insertable magnetic member has a magnetic material composition.

13. The imaging system of claim 10,
wherein the base magnetic member is imbedded in a first area of the mountable plate body; and
wherein the magnetic coupling channel extends from a mounting surface of the mountable plate body through a second area of the mountable plate body to the base magnetic member.

14. The imaging system of claim 13, wherein the base magnetic member is a magnet.

15. The imaging system of claim 10, wherein the insertable magnetic member includes a shaft operable to be concurrently inserted through the mounting channel of the printing plate and into the magnetic coupling channel.

16. The imaging system of claim 15, wherein the insertable magnetic member further includes a head operable to abut a surface of the printable plate body in response to the shaft being concurrently inserted through the mounting channel of the printing plate and into the magnetic coupling channel.

17. The imaging system of claim 15, wherein the shaft abuts the base magnetic member in response to the shaft being concurrently inserted through the mounting channel of the printing plate and into the magnetic coupling channel.

18. The imaging system of claim 17,
wherein the base magnetic member is a magnet; and
wherein the shaft has a magnetic material composition.

19. An imaging method involving a printing plate and a mounting plate, the printing plate including a printable plate body and a mounting channel extending through the printable plate body, the mounting plate including a mountable plate body, a magnetic coupling channel extending into the mountable plate body and a magnetic coupler including a base magnetic member embedded in the mountable plate body and an insertable magnetic member, the imaging method comprising:
mounting the printable plate body onto the mountable plate body; and
inserting the insertable magnetic member through the mounting channel of the printing plate and into the magnetic coupling channel of the mounting plate to thereby magnetically couple the base magnetic member and the insertable magnetic member whereby the printable plate body is securely mounted to the mountable plate body.

20. The imaging method of claim 19, further comprising:
executing at least one of an indicia formation process and a pad printing process subsequent to magnetically coupling the base magnetic member and the insertable magnetic member;
removing the insertable magnetic member from the mounting channel of the printing plate and the magnetic coupling channel of the mounting plate subsequent to forming the indicia on the printable body; and
dismounting the printable plate body from the mountable plate body.
